(19) United States
(12) Patent Application Publication
(10) Pub. No.: US 2007/0206026 A1
(43) Pub. Date: Sep. 6, 2007

(54) Computer readable recording medium recorded with graphics editing program, and graphics editing apparatus

(75) Inventor: Ryohei Morishita, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/477,088

(22) Filed: Jun. 28, 2006

(30) Foreign Application Priority Data
Mar. 2, 2006 (JP) 2006-056118

(51) Int. Cl. G09G 5/00

(52) U.S. Cl. 345/619

(57) ABSTRACT

When an element is interactively deleted in cooperation with an input device and a display device, if the element is in association with more than one element to provide relations thereamong, other elements, obtained by deleting the element to be deleted from more than one element specified by the relations, are associated each other, and a relation thereamong is displayed. Then, by associating other elements to each other upon deletion of the element, the elements are easily in association with each other, while reflecting intention of a user as much as possible.

### BACKGROND OF THE INVENTION

1. Field of the Invention

The present invention generally relates to technology for making elements easily be related to each other, while reflecting intention of a user as much as possible, in graphics editing technology for performing system development or the like in a visual environment using graphics. More particularly, the present invention relates to a computer readable recording medium recorded therein with graphics editing program and a graphics editing apparatus.

2. Description of the Related Art

In recent years, in order to efficiently perform system development or the like in a visual environment, an UML (Unified Modeling Language) tool as a graphics editor has been widely used. The UML tool provides a function of creating and editing a use case diagram, an activity diagram, a state machine diagram, a sequence diagram, and a class diagram or the like, in which various elements are connected by relations, as a basic design diagram of a system. Since it is necessary to associate the elements with one another in an operation of the tool, after arranging the elements, it has been necessary to specify two elements by using an input device such as a mouse to relate them to each other. Therefore, in order to make the elements easily be related to one another, the technology to identify the element existing in the predetermined distance from the newly arranged element, and to automatically relate them to each other, as disclosed in Japanese Unexamined Patent Publication No. 7-325690, has been proposed.

However, since the conventionally proposed technology focuses only on relating the newly arranged element, when editing out or deleting the element related to more than one element, it was necessary to also delete the relation thereamong, and then to associate the two elements again to provide a relation therebetween. Therefore, a simple operation of editing out or deleting the element was not easily performed, so that the graphics editing required a large amount of labor.

Therefore, with a view to solving the above-described problem of the conventional technology, an object of the present invention is to provide graphics editing technology, which makes elements easily be associated with each other to provide a relation thereamong, while reflecting intention of a user as much as possible, when an element related to more than one element is deleted, by associating elements, which were related to the deleted element, with each other.

### SUMMARY OF THE INVENTION

Therefore, in graphics editing technology according to the present invention, when an element is interactively deleted, determination is executed as to whether or not the element is in association with a plurality of elements providing a relation thereamong. Then, when the element to be deleted is in association with more than one element, the remaining elements, which are obtained by deleting the element to be deleted from the more than one element specified by the relation, are association with each other, and a relation provided among those elements is displayed. Therefore, the elements other than the deleted element are in association with each other to provide a relation thereamong upon deletion of the element and thus, the provision of the relation among the elements can be readily accomplished, while reflecting intention of a user as much as possible.

At this stage, for every combination in which two of a plurality of relations involving the element to be deleted are combined, two elements, obtained by deleting the element to be deleted from the three elements specified by the relations, are in association with each other to provide a relation therebetween. By doing so, it is possible to cope with a case where three or more elements are in association with the element to be deleted, such as in a complicated tree structure or mesh structure, not only when the three elements are serially in association with one another.

Another object and aspect of the present invention will be made more apparent from the following detailed description of the embodiment with reference to the accompanying drawings.

### BRIEF DESCRIPTION OF THE DRAWINGS

FIG. 1 is an entire block diagram of a graphics editing apparatus embodying the present invention;

FIG. 2 is a schematic diagram of an element relation table;

FIG. 3 is a schematic diagram of a relation connection table;

FIG. 4 is a flowchart illustrating processing contents of a graphics editing program;

FIG. 5 is a schematic diagram of an operation outline of the graphics editing apparatus;

FIG. 6 is a schematic diagram of the element relation table updated upon deletion of an element; and

FIG. 7 is a schematic diagram of the relation connection table updated upon the deletion of the element.

### DESCRPTION OF THE PREFERRED EMBODIMENT

Hereinafter, the present invention will be described in detail with reference to the attached drawings.

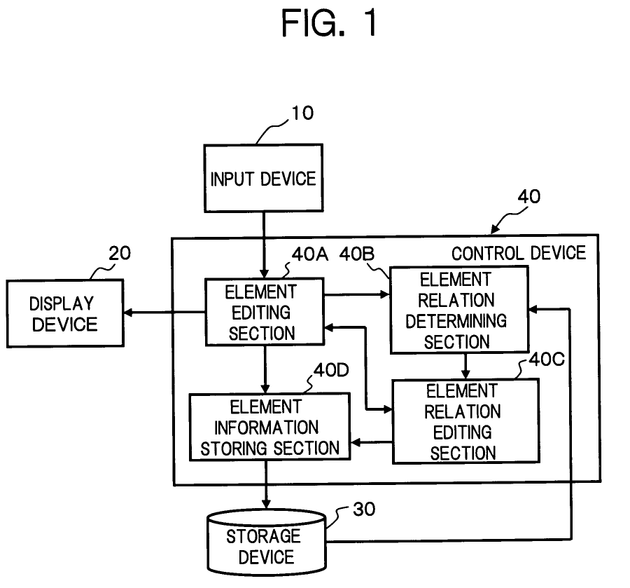

FIG. 1 is a view showing an entire structure of a graphics editing apparatus embodying graphics editing technology according to the present invention.

The graphics editing apparatus is constructed by installing a graphics editing program recorded in a computer readable recording medium, such as a CD-ROM and a DVD-ROM, to a general-purpose computer, such as a PC (Personal Computer). Specifically, the graphics editing apparatus is comprised of an input device 10 provided with a pointing device such as a mouse and a keyboard, a display device 20 such as a CRT (Cathode Ray Tube) or an LCD (Liquid Crystal Display), a storage device 30 such as a hard disc, and a control device 40 provided with a memory and a CPU (Central Processing Unit).

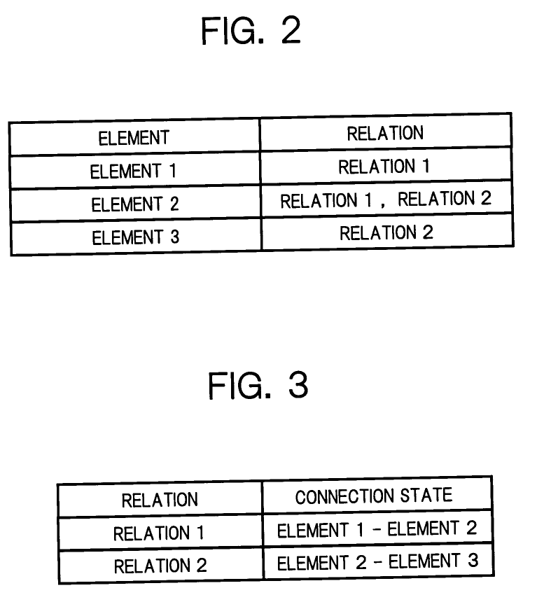

An element relation table as shown in FIG. 2 and a relation connection table as shown in FIG. 3 are each registered in the storage device 30, as information of an element composing a fundamental design diagram of a system or the like, in addition to a property describing a kind and a position thereof or the like. In the element relation table, relations of each of the elements are described as being related thereto, and in the relation connection table, connection statuses between the elements are described as being related to each of the relations.

On the other hand, in the control device 40, by executing the graphics editing program, an element editing section 40A, an element relation determining section 40B, an element relation editing section 40C, and an element information storing section 40D are each realized. The element editing section 40A provides a function to interactively edit the element in cooperation with the input device 10 and the display device 20. Herein, the term “editing” is intended to mean at least arrangement and deletion of an element. The element relation determining section 40B provides a function, when the element is deleted by the element editing section 40A, to refer to the element relation table registered in the storage device 30 to determine whether or not the element is associated with more than one element. The element relation editing section 40C provides a function, when the element relation determining section 40B determines that the delete element is in association with more than one element, to refer to each of the element relation table and the relation connection table registered in the storage device 30, and to associate the elements, obtained by deleting the element to be deleted (hereinafter, referred to as “delete element”) from more than one element specified by the relations, with each other. The element information storing section 40D provides a function, when the element is arranged by the element editing section 40A, to register a property of the element in the storage device 30. The element information storing section 40D further provides a function, when the elements are associated with each other by the element relation editing section 40C, to update each of the element relation table and the relation connection table registered in the storage device 30. In addition, the element editing section 40A also provides a function, when the elements are related to each other by the element relation editing section 40C, to redisplay the relation on the display device 20.

Herein, an element editing step, element editing means, a relation display step, and relation display means are each realized by the element editing section 40A, and a relation determining step and relation determining means are each realized by the element relation determining section 40B. In addition, an associating step and associating means are each realized by the element relation editing section 40C.

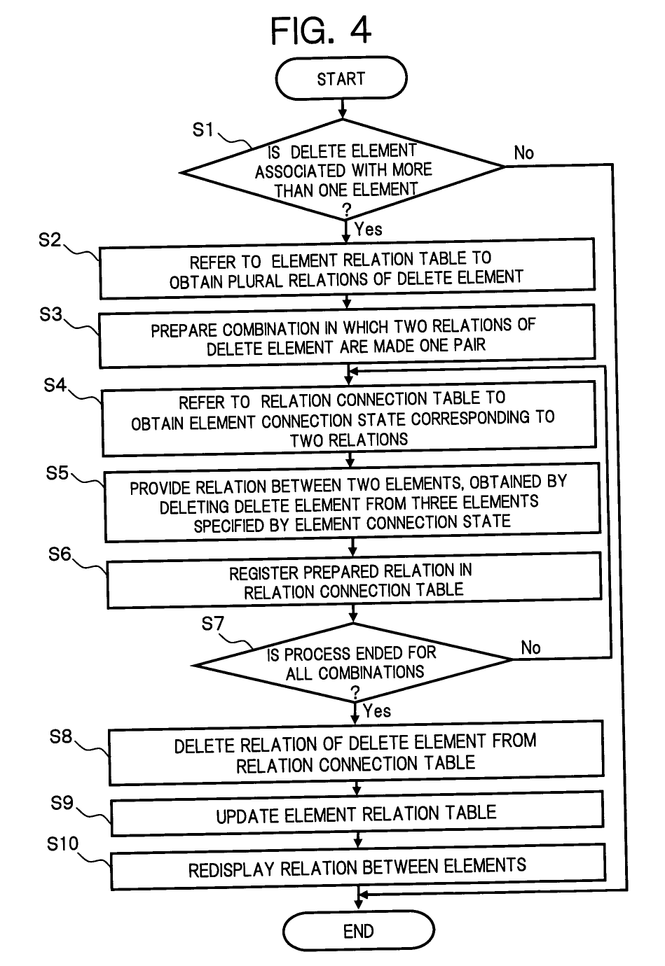

FIG. 4 shows process contents of the graphics editing program executed in the control device 40 in the wake of interactive deletion of the element.

In Step 1 (abbreviated as “S1” in the drawing figure, likewise hereinafter), by referring to the element relation table registered in the storage device 30, it is determined whether or not the delete element is associated with more than one element. Then, if the delete element is associated with more than one element, the operation proceeds to Step S2 (Yes); on the other hand, if the delete element is not associated with more than one element, the process ends (No).

In Step 2, by referring again to the element relation table registered in the storage device 30, plural relations in association with the delete element are obtained.

In Step 3, a combination or combinations is created in which two of the obtained plural relations are combined.

In Step 4, by referring to the relation connection table registered in the storage device 30, connection statuses of elements corresponding to the two relations composing the combination are obtained. Herein, each of the combinations created in Step 3 is sequentially applied, as the combination.

In Step 5, there is created a relation, which associates two elements, obtained by deleting the delete element from the three elements specified by the element connection status, with each other.

In Step 6, the created relation is additionally registered in the relation connection table registered in the storage device 30.

In Step 7, it is determined whether or not a process is performed for all of the combinations. Then, if the process is performed for all of the combinations, the operation proceeds to Step 8 (Yes); on the other hand, if the process is not performed for all of the combinations, the operation returns to Step 4 (No).

In Step 8, the relation, which was associated with the delete element, is deleted from the relation connection table registered in the storage device 30.

In Step 9, the delete element and the relation thereof is deleted from the element relation table registered in the storage device 30, and the relation among other elements specified by the relation of the delete element is replaced by a new relation.

In Step 10, the relation between each of the elements is redisplayed on the display device 20.

According to such a graphics editing apparatus, if the delete element is associated with more than one element when the element is interactively deleted in cooperation with the input device 10 and the display device 20, the element relation table is referred to and the combination or combinations, in which two of the plurality of relations are combined, is created. In addition, for each of the created combinations, the two elements, obtained by deleting the delete element from the three elements specified by the two relations composing the combination, are associated with each other, and the relation is registered in the relation connection table. Subsequently, while the relation of the delete element is deleted from the relation connection table, the delete element and the relation thereof are deleted from the element relation table, and the relation of other elements is replaced by a new relation, then the relation among the elements is redisplayed on the display device 20.

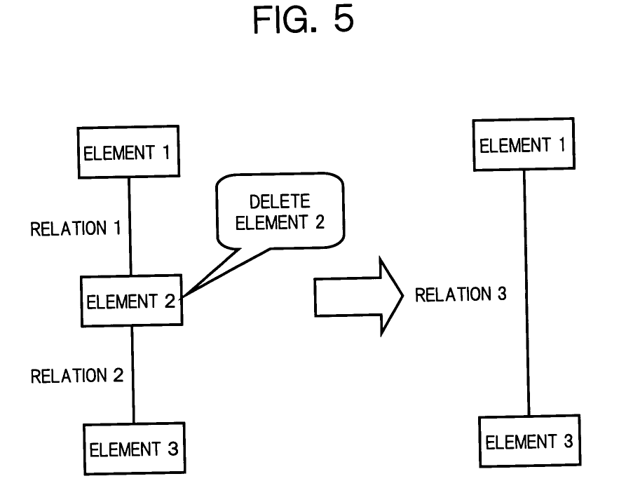

Herein, in order to make a relation process between the elements by the graphics editing apparatus more easily comprehended, a process when deleting an element 2 is described in time series manner, on the assumption that the graphic is such that elements 1 and 2 and elements 2 and 3 are associated with each other by relations 1 and 2, respectively, as shown in FIG. 5.

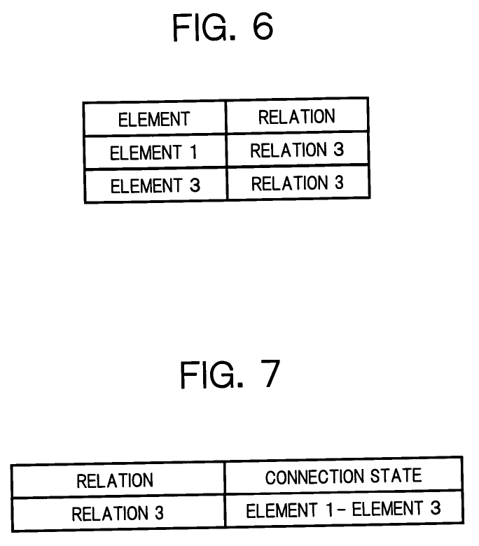

When the element 2 is deleted, the element relation table shown in FIG. 2 is referred to, and it is determined that the two relations 1 and 2 are related to the element 2. Then, after the combination in which two of the plural relations are combined (relations 1 and 2) is created, the relation connection table shown in FIG. 3 is referred to, and a relation 3 is created, in which the two elements (elements 1 and 3) obtained by deleting the delete element (element 2) from the three elements (elements 1, 2 and 3) specified by the relations are associated with each other. After that, based on the created relation 3, the element relation table and the relation connection table are each updated as shown in FIGS. 6 and 7, respectively, and the relation among the elements is redisplayed on the display device 20.

Therefore, when the element associated with more than one element is deleted, it is possible to readily associate the elements with each other, while reflecting intention of a user as much as possible, by associating the elements, which were associated with the deleted element, with each other. In addition, since the elements are associated with each other for every combination in which two of the plural relations of the delete element are combined, it may cope with a case where three or more elements are related to the element to be deleted, such as in a complicated tree structure or mesh structure, not only when the three elements are serially related.

Furthermore, the present invention is not limited to a “UML tool”, but may be applied to software for creating a flowchart, or a CAD.

I claim:

1. A computer readable recording medium recorded therein with a graphics editing program adapted for being realized by a computer, comprising the steps of:
editing interactively an element in cooperation with an input device and a display device;
determining, when the element has been deleted by said editing step, whether or not the element is in association with more than one element;
associating, when the element to be deleted is determined by said relation determining step that said element is in association with more than one element, elements obtained by deleting the element to be deleted from more than one element specified by relation by the association, with one another to provide a relation thereamong; and
displaying the relation among the elements in association with each other by said associating step on said display device.

2. The computer readable recording medium recorded therein with the graphics editing program according to claim 1, wherein said associating step associates, for every combination in which two of plural relations provided for said element to be deleted are combined, two elements obtained by deleting the element to be deleted from three elements specified by the combined relations, with each other.

3. A graphics editing apparatus comprising:
element editing means for interactively editing elements;
relation determining means for determining, when an element is deleted by said element editing means, whether or not the element is in association with more than one element;
associating means for associating, when the element to be deleted is determined to be in association with more than one element, by said relation determining means, elements, obtained by deleting the element to be deleted from plural elements specified by relations by the association, with each other to provide a relation thereamong; and
relation display means for displaying relations among elements in association with each other by said associating means.
